(19) United States
(12) Patent Application Publication
(10) Pub. No.: US 2007/0097146 A1
(43) Pub. Date: May 3, 2007

(54) Resampling selected colors of video information using a programmable graphics processing unit to provide improved color rendering on LCD displays

(75) Inventor: Sean Matthew Gies, Campbell, CA (US)

Correspondence Address: WONG, CABELLO, LUTSCH, RUTHERFORD & BRUCCULERI,;L.L.P., 20333 SH 249, SUITE 600, HOUSTON, TX, 77070, US

(73) Assignee: Apple Computer, Inc., Cupertino, CA (US)

(21) Appl. No.: 11/261,382

(22) Filed: Oct. 27, 2005

(51) Int. Cl. G09G 5/00

(52) U.S. Cl. 345/613

(57) ABSTRACT

A system which utilizes the processing capabilities of the graphics processing unit (GPU) in the graphics controller. Each frame of each video stream is decoded and converted to RGB values. The R and B values are resampled as appropriate using the GPU to provide values corresponding to the proper, slightly displaced locations on the display device. The resampled values for R and B and the original G values are provided to the frame buffer for final display. Each of these operations is done in real time for each frame of the video. Because each frame has had the color values resampled to provide a more appropriate value for the actual subpixel location the final displayed image more accurately reproduces the original color image.

### RELATED APPLICATIONS

The subject matter of the invention is generally related to the following jointly owned and co-pending patent application: “Display-Wide Visual Effects for a Windowing System Using a Programmable Graphics Processing Unit” by Ralph Brunner and John Harper, Ser. No. 10/877,358, filed Jun. 25, 2004, and “Resampling Chroma Video Using a Programmable Graphics Processing Unit to Provide Improved Color Rendering” by Sean Gies, Ser. No. ______ filed concurrently herewith, which are incorporated herein by reference in their entirety.

### BACKGROUND

The invention relates generally to computer display technology and, more particularly, to the application of visual effects using a programmable graphics processing unit during frame-buffer composition in a computer system.

Presentation of video on digital devices is becoming more common with the increases in processing power, storage capability and telecommunications speed. Programs such as QuickTime by Apple Computer, Inc., allow the display of various video formats on a computer. In operation, QuickTime must decode each frame of the video from its encoded format and then provide the decoded image to a compositor in the operating system for display.

Conventionally it is assumed that the R, G and B subpixels are located at the same position when video images are being displayed and the luminance values are provided accordingly. As this is not the case in many instances, particularly including in LCD displays which provide columns of R, G and B subpixels, the color rendering of the image is degraded.

ClearType, a font rendering technology from Microsoft Corporation, uses the fact that LCD displays provide the R, G and B subpixel columns to provide improved rendering of text characters. Font rendering is heavily focused on reducing pixilation or the jagged edges which appear on diagonal lines. ClearType uses the fact that the columns are evenly spaced to effectively triple the horizontal resolution of the LCD display for font rendering purposes. All of the subpixels are provided at the normal brightness or luminance as would otherwise be done, so that the character appears normally, just with less pixilation.

It would be beneficial to provide a mechanism by which video images are improved when displayed on devices where the color subpixels are not co-located.

### SUMMARY

A system according to the present invention utilizes the processing capabilities of the graphics processing unit (GPU) in the graphics controller. Each frame of each video stream is decoded and converted to RGB values. The R and B values are resampled as appropriate using the GPU to provide values corresponding to the proper, slightly displaced locations on the display device. The resampled values for R and B and the original G values are provided to the frame buffer for final display. Each of these operations is done in real time for each frame of the video. Because each frame has had the color values resampled to provide a more appropriate value for the actual subpixel location, rather than just assuming the subpixels are co-located as previously done, the final displayed image more accurately reproduces the original color image.

### BRIEF DESCRIPTION OF THE DRAWINGS

FIG. 1 shows an illustration of a computer system with various video sources and displays.

FIG. 2 shows an exemplary block diagram of the computer of FIG. 1.

FIG. 3 illustrates the original sampling locations, conventional image development and resampled image development according to the present invention.

FIG. 4 shows an exemplary software environment of the computer of FIG. 1.

FIG. 5 shows a flowchart of operation of video software of a first embodiment according to the present invention.

FIG. 6 shows operations and data of a graphics processing unit of the first embodiment.

FIG. 7 shows a flowchart of operation of video software of a second embodiment according to the present invention.

FIG. 8 shows operations and data of a graphics processing unit of the second embodiment.

### DETAILED DESCRIPTION

Methods and devices to provide real time video color compensation using fragment programs executing on a programmable graphics processing unit are described. The compensation can be done for multiple video streams and compensates for the subpixel positions of the red, green and blue elements of the display device. The following embodiments of the invention, described in terms of the Mac OS X window server and compositing application and the QuickTime video application, are illustrative only and are not to be considered limiting in any respect. (The Mac OS X operating system and QuickTime are developed, distributed and supported by Apple Computer, Inc. of Cupertino, Calif.)

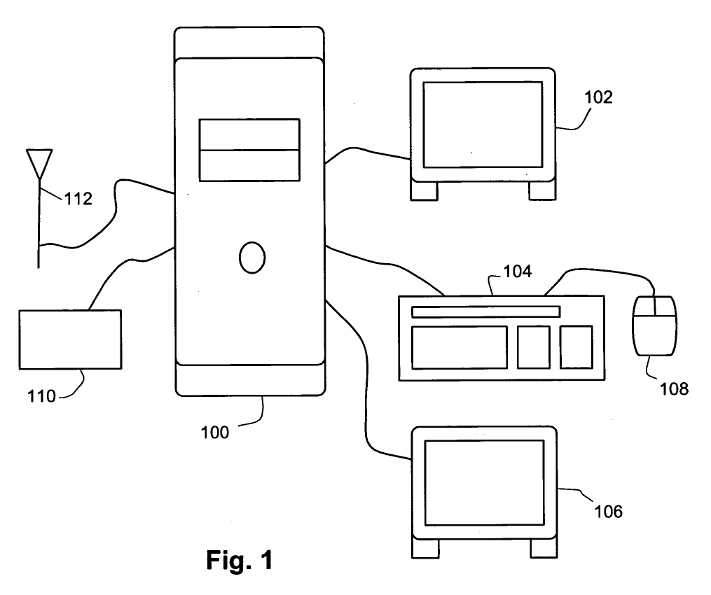

Referring now to FIG. 1, a computer system is shown. A computer 100, such as a PowerMac G5 from Apple Computer, Inc., has connected a monitor or graphics display 102 and a keyboard 104. A mouse or pointing device 108 is connected to the keyboard 104. A video display 106 is also connected for video display purposes in certain embodiments. The display 102 is more commonly used for video display, and then it is usually done in a window in the graphic display.

A video camera 110 is shown connected to the computer 100 to provide a first video source. A cable television device 112 is shown as a second video source for the computer 100.

It is understood that this is an exemplary computer system and numerous other configurations and devices can be used.

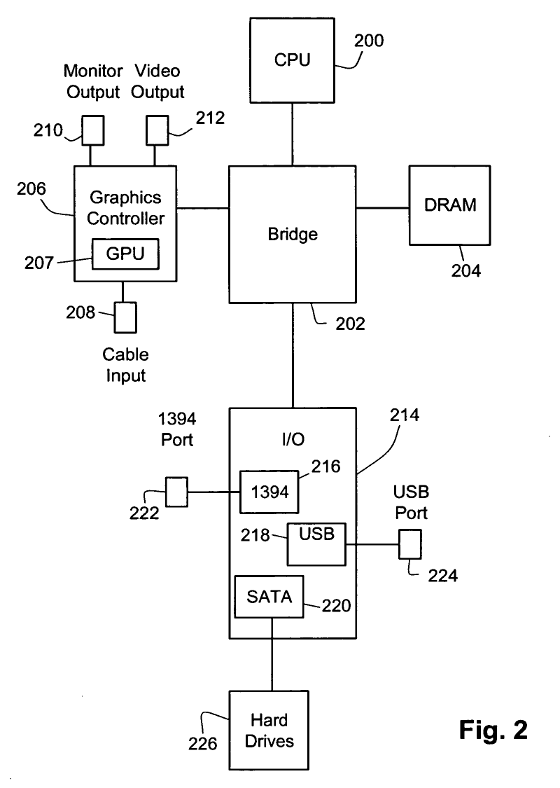

Referring to FIG. 2, an exemplary block diagram of the computer 100 is shown. A CPU 200 is connected to a bridge 202. DRAM 204 is connected to the bridge 202 to form the working memory for the CPU 200. A graphics controller 206, which preferably includes a graphics processing unit (GPU) 207, is connected to the bridge 202. The graphics controller 206 is shown including a cable input 208, for connection to the cable device 112; a monitor output 210, for connection to the graphics display 102; and a video output 212, for connection to the video display 106.

An I/O chip 214 is connected to the bridge 202 and includes a 1394 or FireWire™ block 216, a USB (Universal Serial Bus) block 218 and a SATA (Serial ATA) block 220. A 1394 port 222 is connected to the 1394 block 216 to receive devices such as the video camera 110. A USB port 224 is connected to the USB block 218 to receive devices such as the keyboard 104 or various other USB devices such as hard drives or video converters. Hard drives 226 are connected to the SATA bock 220 to provide bulk storage for the computer 100.

It is understood that this is an exemplary block diagram and numerous other arrangements and components could be used.

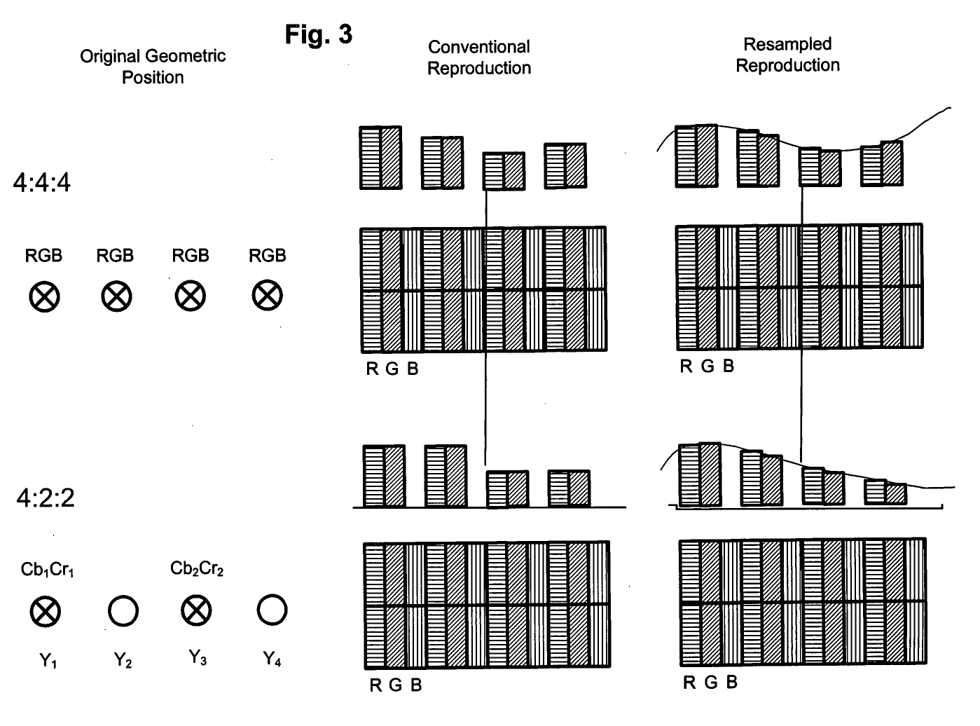

Referring then to FIG. 3, various digital video data formats are illustrated. The first column is the geometric position of the original image pixels and the sampling locations of the red, green and blue values. The second column is a graphic illustrating the conventional reproduction techniques for that particular format. The final column is the results of the resampled format according to the present invention.

Referring to FIG. 3, a first video format referred to as 4:4:4, which is generally RGB, is shown. As can be seen, each of the R, G and B values is sampled at an identical location as indicated by the circle and the X for each pixel. Proceeding then to a second column, which indicates conventional reproduction on an LCD display, it can be seen that the lower of the two illustrations indicates the arrangement of the LCD itself to show that the R, G and B subpixels are located in adjacent columns and are not co-located. Above that illustration are four pixel values effectively representing those illustrated to the left. In this embodiment the brightness or luminance values for the R and G subpixels have been assumed to be identical and a zero value is assumed for blue subpixels for illustration purposes. Proceeding to the right or third column, this is the sampled reproduction illustration. Again the columns of the LCD display are provided for reference. Above that are the amplitudes or luminance values of the resampled subpixel values to compensate for the actual location variance between the three columns. A curve is drawn to show a continuous-tone curve based on the varying values. As can be seen in the resampled reproduction illustration the luminance or amplitude values of the R and G subpixels is actually varied to allow the subpixel value to better match the continuous-tone curve as illustrated. The illustrated sampling is done with an algorithm such as those based on the sinc function

$$\{ \begin{matrix}\frac{sin ( x )}{x} \text{:} x \neq 0 \\ 1 \text{:} x = 0\end{matrix} ,$$

but other algorithms can be utilized if desired, such as linear interpolation and so on as well known to those skilled in the art. Thus, by resampling the actual R and B values based on their slightly skewed locations in relation to the G subpixel value, which is effectively co-sited with the original pixel locations, a better approximation is developed of the original values, had the original values been sampled slightly askew as being reproduced on the LCD display.

The lower half of FIG. 3 illustrates a similar approach where compressed digital video, in this case in the 4:2:2 format, is received. This can be seen in the Cb and Cr samples at the first and third luminance pixel locations. Conventional reproduction would duplicate or smear the chroma values to the second and fourth locations. In embodiments according to the preferred invention and as more fully described in U.S. patent application Ser. No. ______, entitled “Resampled Chroma Video Using a Programmable Graphics Processor Unit to Provide Improved Color Rendering,” as referenced above, chroma values are provided for each actual luminance value. Then according to the present invention, further resampling is done to better match the actual sampling curve as illustrated in the drawing for the R and B subpixels to better correlate to the original image. In the preferred embodiment the resampling is performed using a fragment program in the GPU. Fragment programming is described in more detail in Ser. No. 10/877,358 as also referenced above.

Thus it can be readily seen in FIG. 3 that resampling the R and B subpixel values to compensate for the slightly different positioning of the R and B subpixels instead of merely assuming they are co-located with the G subpixel provides improved color rendition or reproduction.

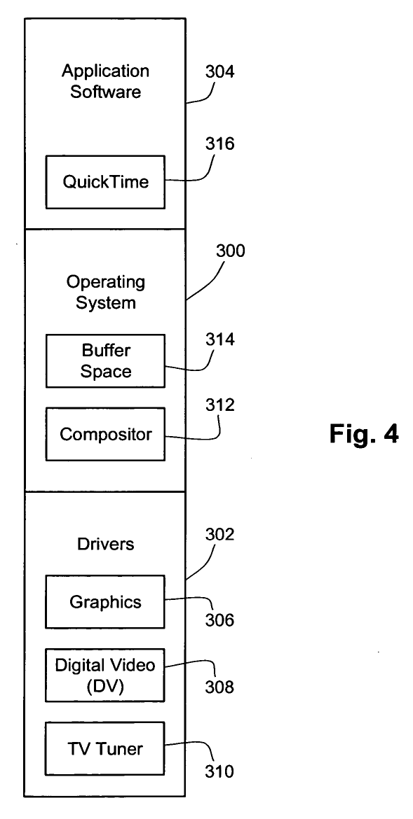

Referring them to FIG. 4, a drawing of exemplary software present on the computer 100 is shown. An operating system, such as Mac OS X by Apple Computer, Inc., forms the core piece of software. Various device drivers 302 sit below the operating system 300 and provide interface to the various physical devices. Application software 304 runs on the operating system 300.

Exemplary drivers are a graphics driver 306 used with the graphics controller 206, a digital video (DV) driver 308 used with the video camera 110 to decode digital video, and a TV tuner driver 310 to work with the graphics controller 206 to control the tuner functions.

Particularly relevant to the present invention are two modules in the operating system 300, specifically the compositor 312 and buffer space 314. The compositor 312 has the responsibility of receiving the content from each application for that application's window and combining the content into the final displayed image. The buffer space 314 is used by the applications 304 and the compositor 312 to provide the content and develop the final image.

The exemplary application is QuickTime 316, a video player program in its simplest form. QuickTime can play video from numerous sources, including the cable, video camera and stored video files.

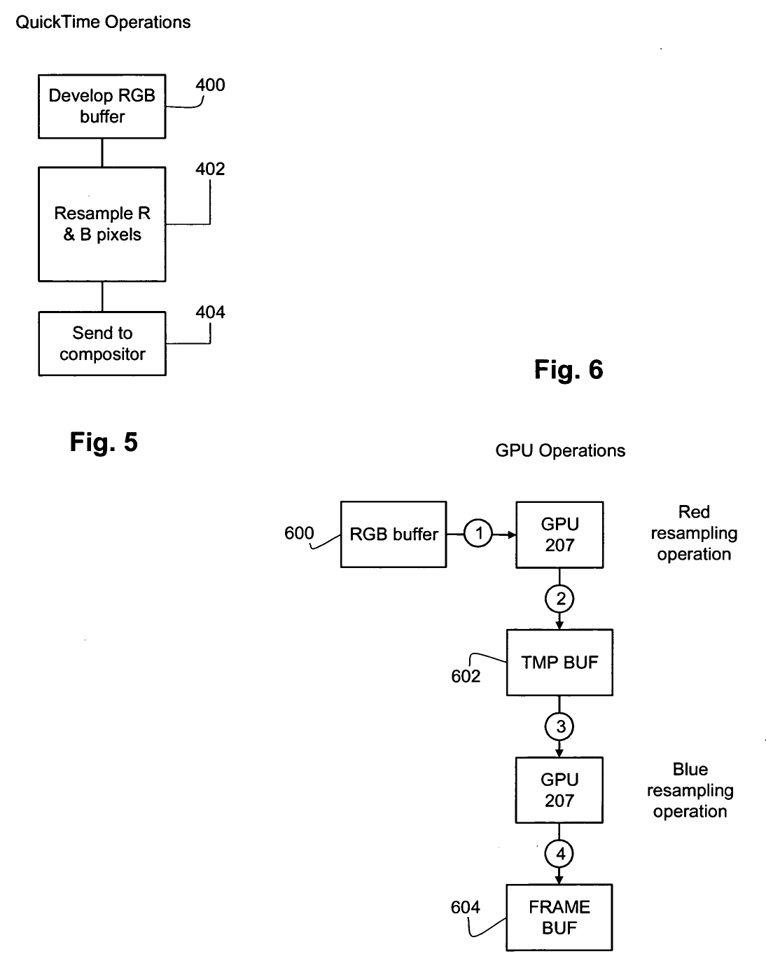

Having set this background, and referring then to FIG. 5, the operations of the QuickTime application 316 are illustrated. In step 400 the QuickTime application 316 decodes the video and develops a buffer containing R, G and B values. This can be done using conventional techniques or improved techniques such as those shown in the “Resampling Chroma Video” application mentioned above and U.S. patent application Ser. No. 11/113,817, entitled “Color Correction of Digital Video Images Using a Programmable Graphics Processing Unit”, by Sean Gies, James Batson and Tim Cherna, filed Apr. 25, 2005, which is hereby incorporated by reference. Further, the video can come from real time sources or from a stored or streaming video file. After the QuickTime application 316 develops the RGB buffer in step 402, the R and B values are resampled as described above by using fragment programs on the GPU to provide R and B values for each subpixel location. In step 404 this buffer with the resampled R and B values and original G values is provided to the compositor. It is also understood that these steps are performed for each frame in the video.

Referring then to FIG. 6, an illustration of the various data sources and operations of the GPU 207 are shown. An RGB buffer 600 is provided to the GPU 207 in operation \textcircled{1}. Then in operation \textcircled{2} the GPU 207 resamples the R values using the proper resampling fragment program and renders the buffer into a TMP or temporary buffer 602. Any use of temporary buffers in the resampling process is omitted in FIG. 6 for clarity. The TMP buffer 602 is provided in operation \textcircled{3} to the GPU 207. In operation \textcircled{4} the GPU 207 resamples the B values in the TMP buffer 602 and provides the results to the frame buffer 604.

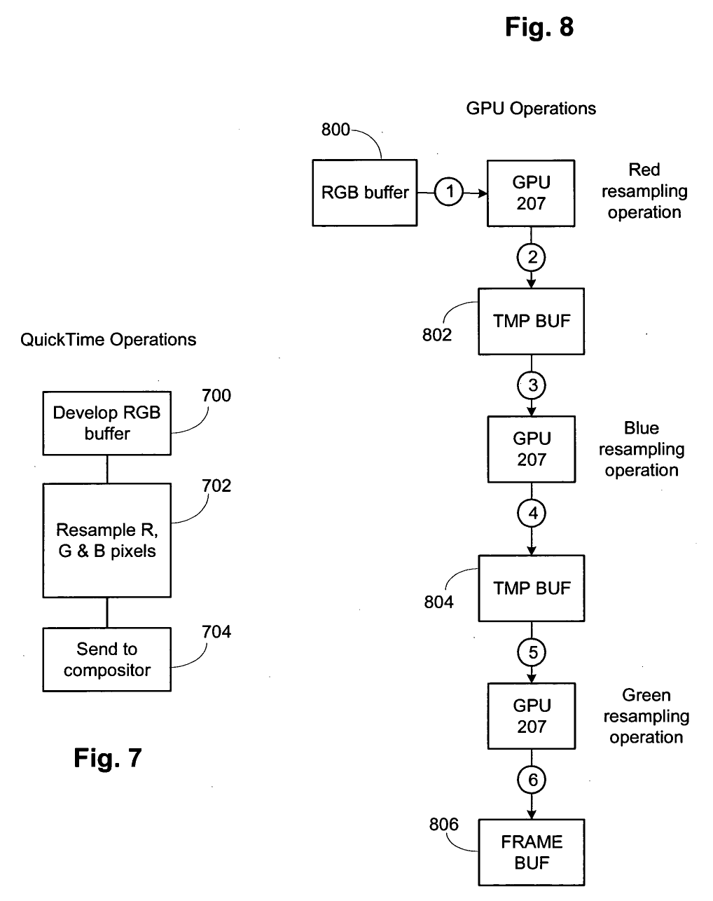

FIGS. 5 and 6 have described the simplest example of equal size, two color-only resampling according to the present invention. It is understood that many other cases will occur. The most common may be where the source image has a greater resolution than the image to be displayed and where the image has been partially shifted. Thus the source image must be resampled to reduce its resolution to the desired size and the final image must also be resampled to adjust for the display subpixel locations. While this could be done in two sets of operations as just described, it preferably is performed in one operation set to avoid the destructive nature of repeated resampling operations. These combined operations are described in FIGS. 7 and 8.

In FIG. 7, as before, the QuickTime application 316 decodes the video and develops an RGB buffer in step 700. In step 702 the R, G and B values are all resampled, with each resampling operation taking into account both the image size change and the subpixel locations of the display device, thus effectively combining two different resampling operations. In step 704 the buffer with the resampled values is provided to the compositor.

FIG. 8 illustrates the resampling of each color, for image size differences and subpixel locations as appropriate. The RGB buffer 800 is provided to the GPU 207 in operation \textcircled{1}. Then in operation \textcircled{2} the GPU 207 resamples the R values using the proper resampling fragment programs and renders the buffer into a TMP buffer 802. This TMP buffer 802 is provided to the GPU 207 in operation \textcircled{3}. In operation \textcircled{4} the GPU 207 performs a similar resampling on the B values and provides the results to a TMP buffer 804. In operation \textcircled{5} the TMP buffer 804 is provided to the GPU 207. In operation \textcircled{6} the GPU 207 resamples the G values and provides the results to the frame buffer 806.

The various buffers can be located in either the DRAM 204 or in memory contained on the graphics controller 206, though the frame buffer is almost always contained on the graphics controller for performance reasons.

Thus an efficient method of performing subpixel resampling from video source to final display device has been described. Use of the GPU and its fragment programs provides sufficient computational power to perform the operations in real time, as opposed to the CPU, which cannot perform the calculations in real time. Therefore, because of the resampling of the R and B values, the video is displayed with more accurate colors on LCD displays.

Various changes in the components as well as in the details of the illustrated operational methods are possible without departing from the scope of the following claims. For instance, in the illustrative system of FIGS. 1, 2 and 3 there may be additional assembly buffers, temporary buffers, frame buffers and/or GPUs. In addition, acts in accordance with FIG. 6 may be performed by two or more cooperatively coupled GPUs and may, further, receive input from one or more system processing units (e.g., CPUs). It will further be understood that fragment programs may be organized into one or more modules and, as such, may be tangibly embodied as program code stored in any suitable storage device. Storage devices suitable for use in this manner include, but are not limited to: magnetic disks (fixed, floppy, and removable) and tape; optical media such as CD-ROMs and digital video disks (“DVDs”); and semiconductor memory devices such as Electrically Programmable Read-Only Memory (“EPROM”), Electrically Erasable Programmable Read-Only Memory (“EEPROM”), Programmable Gate Arrays and flash devices. It is further understood that the video source can be any video source, be it live or stored, and in any video format.

While an LCD display has been used as the exemplary display type having subpixels in defined locations, other display types such as plasma and field emission may also be used with the present invention. Further, while a subpixel ordering of RGB has been used as exemplary, other orderings, such as RBG, BRG, BGR and so on can be used. Even further, while a columnar arrangement of the subpixels has been used as exemplary, other geometries, such as a triad, can be used. Additionally, while resampling of only two of three subpixel locations has been described in certain examples, in many cases it may be appropriate to resample for all three subpixel locations.

Further information on fragment programming on a GPU can be found in U.S. patent applications Ser. Nos. 10/826,762, entitled “High-Level Program Interface for Graphics Operations,” filed Apr. 16, 2004 and 10/826,596, entitled “Improved Blur Computation Algorithm,” filed Apr. 16, 2004, both of which are hereby incorporated by reference.

The preceding description was presented to enable any person skilled in the art to make and use the invention as claimed and is provided in the context of the particular examples discussed above, variations of which will be readily apparent to those skilled in the art. Accordingly, the claims appended hereto are not intended to be limited by the disclosed embodiments, but are to be accorded their widest scope consistent with the principles and features disclosed herein.

What is claimed is:

1. A method for displaying digital video on a display device, comprising:
decoding digital video information into R, G and B subpixel values; and
resampling the decoded R, G and B subpixel values to compensate for the relative locations of the R, G and B subpixels on the display device.

2. The method of claim 1, wherein the resampling is performed using a linear function.

3. The method of claim 1, wherein the resampling is performed based on the sinc function.

4. The method of claim 1, wherein the display device is an LCD and has the R, G and B subpixels arranged in columns, with one of the subpixels co-sited with the original pixel locations, wherein the step of resampling includes:
resampling a first set of subpixel values to compensate for the location of those subpixels relative to the co-sited subpixels; and
resampling a second set of subpixel values to compensate for the location of those subpixels relative to the co-sited subpixels.

5. The method of claim 4, wherein the G subpixels are the co-sited subpixels and the R and B subpixels are resampled.

6. The method of claim 1, further comprising:
performing a second resampling operation in conjunction with the subpixel location compensation resampling.

7. The method of claim 6, wherein the second resampling operation changes the image size.

8. The method of claim 7, wherein the change in size is a decrease in image size.

9. The method of claim 1, wherein the resampling is performed in a graphics processing unit.

10. A computer readable medium or media having computer-executable instructions stored therein for performing the following method for displaying digital video on a display device, the method comprising:
decoding digital video information into R, G and B subpixel values; and
resampling the decoded R, G and B subpixel values to compensate for the relative locations of the R, G and B subpixels on the display device.

11. The computer readable medium or media of claim 10, wherein the resampling is performed using a linear function.

12. The computer readable medium or media of claim 10, wherein the resampling is performed based on the sinc function.

13. The method of claim 10, further comprising:
performing a second resampling operation in conjunction with the subpixel location compensation resampling.

14. The method of claim 13, wherein the second resampling operation changes the image size.

15. The method of claim 14, wherein the change in size 13 is a decrease in image size.

16. The computer readable medium or media of claim 10, wherein the display device is an LCD and has the R, G and B subpixels arranged in columns, with one of the subpixels co-sited with the original pixel locations, wherein the step of resampling includes:
resampling a first set of subpixel values to compensate for the location of those subpixels relative to the co-sited subpixels; and
resampling a second set of subpixel values to compensate for the location of those subpixels relative to the co-sited subpixels.

17. The computer readable medium or media of claim 16, wherein the G subpixels are the co-sited subpixels and the R and B subpixels are resampled.

18. The computer readable medium or media of claim 10, wherein the resampling is performed in a graphics processing unit

19. A computer system comprising:
a central processing unit;
memory, operatively coupled to the central processing unit, said memory adapted to provide a plurality of buffers, including a frame buffer;
a display port operatively coupled to the frame buffer and adapted to couple to a display device;
a graphics processing unit, operatively coupled to the memory; and
one or more programs for causing the graphics processing unit to perform the following method, the method including:
decoding digital video information into R, G and B subpixel values; and
resampling the decoded R, G and B subpixel values to compensate for the relative locations of the R, G and B subpixels on the display device.

20. The computer system of claim 19, wherein the resampling is performed using a linear function.

21. The computer system of claim 19, wherein the resampling is performed using a sinc function.

22. The computer system of claim 19, wherein the display device is an LCD and has the R, G and B subpixels arranged in columns, with one of the subpixels co-sited with the original pixel locations, wherein the step of resampling includes:
resampling a first set of subpixel values to compensate for the location of those subpixels relative to the co-sited subpixels; and
resampling a second set of subpixel values to compensate for the location of those subpixels relative to the co-sited subpixels.

23. The computer system of claim 22, wherein the G subpixels are the co-sited subpixels are the co-sited subpixels and the R and B subpixels are resampled

24. The computer system of claim 19, the method further including:
performing a second resampling operation in conjunction with the subpixel location compensation resampling.

25. The computer system of claim 24, wherein the second resampling operation changes the image size.

26. The computer system of claim 25, wherein the change in size is a decrease in image size.
